(19) United States
(12) Patent Application Publication
(10) Pub. No.: US 2014/0316870 A1
(43) Pub. Date: Oct. 23, 2014

(54) PROMOTION OF CUSTOMER ACQUISITION ENGAGEMENTS WITH ONLINE ACCESSING CONTENT

(71) Applicant: Zynga Inc., San Francisco, CA (US)

(72) Inventors: Joshua Marc Burgin, Seattle, WA (US); Simon Asselin, Sammamish, WA (US)

(21) Appl. No.: 14/194,666

(22) Filed: Feb. 28, 2014

Related U.S. Application Data
(60) Provisional application No. 61/770,527, filed on Feb. 28, 2013.

(51) Int. Cl. G06Q 30/02

(52) U.S. Cl. CPC G06Q 30/0209; G06Q 30/0277
USPC 705/14.12; 705/14.73

(57) ABSTRACT

A system and method for managing a computer-implemented online game provides an in-game advertising publication service to publish interactive advertising content within a computer-implemented game in accordance with a pricing structure that defines different prices for different types of player engagement, for example having a cost per acquisition (CPA) pricing mechanism and a cost per engagement (CPE) pricing mechanism. A linked sequence of prompts is presented on a user device, to prompt a series of player engagements including at least two different engagement types. In some instances, a CPA prompt is presented earlier in the sequence, with an associated CPE prompt being presented subsequent to player engagement pursuant to the CPA prompt.

This application claims the benefit of priority to U.S. Provisional Patent Application Ser. No. 61/770,527, filed on Feb. 28, 2013, which is incorporated by reference herein in its entirety.

### FIELD

This disclosure generally relates to online advertising. The invention also relates to online social games and, more specifically, to presenting advertising content within an online game.

### BACKGROUND

Many online games present advertisements and other advertising content or advertising content to players of the online games. For example, some online games may display static or dynamic advertisements within the game

Some advertising content may be interactive and may be associated with corresponding rewards, so that user interaction with the content is a condition for achieving a corresponding reward. In this way, active player engagement with the advertising content is promoted, improving exposure of a brand or product promoted in the advertising content.

### BRIEF DESCRIPTION OF THE DRAWINGS

The example embodiments are illustrated by way of example, and not limitation, in the figures of the accompanying drawings, in which like reference numerals indicate the same or similar elements unless otherwise indicated.

FIG. 1 shows a schematic diagram of a virtual gaming system, according to some example embodiments.

FIG. 2 shows a social network within a social graph, according to some example embodiments.

FIG. 3 is a block diagram illustrating an integrated in-game advertising platform, in some example embodiments.

FIG. 4 is a block diagram illustrating an interface system, in some example embodiments.

FIG. 5 is a flow diagram illustrating a method for presenting interactive advertising content to a player of an online game, in some example embodiments.

FIG. 6A-6B are flow diagrams illustrating a method for presenting a sequence of sponsored activities to a player of an online game, in some example embodiments.

FIGS. 7A-7B are display diagrams illustrating example displays of sponsored interactive content, in some example embodiments.

FIGS. 8A-8B are flow diagrams illustrating a method for presenting a sequence of sponsored activities to a player of an online game, in some example embodiments.

FIGS. 9A-9C depicts example interactive content displayed on a user device for a sequence of player engagements, in an example embodiment.

FIGS. 10A-10C depicts example interactive content displayed on a user device for a sequence of player engagements, in another example embodiment.

FIG. 11 illustrates data flow between example components of the example system of FIG. 1.

FIG. 12 illustrates an example network environment in which various embodiments may operate.

FIG. 13 illustrates an example computing system architecture, which may be used to implement one or more of the methodologies described herein.

### DESCRIPTION OF EXAMPLE EMBODIMENTS

### Overview

Example embodiments described below disclose methods and systems for facilitating player engagement with online advertising content. Example methods comprise providing an in-game advertising publication service to publish interactive advertising content within a computer-implemented game, with the game serving an advertising platform for interactive content.

In-game publication of the advertising content may be to generate advertising revenue from one or more advertisers associated with the published content. Pricing for publication services provided to the advertisers may be in accordance with an outcome-based pricing structure or scheme, wherein advertising costs incurred by the advertiser (and thus due to the publisher) is variable as a function of player interactions resulting from publication of the advertising content. The term “player interaction” means an activity that is prompted or results from the publication of the advertising content, the activity being performed by a player of the game, and the activity being performed with respect to the advertising content or with respect to with respect to the advertiser.

The system may be configured to implement a pay-per-engagement pricing structure, in which the advertiser incurs advertising costs only for player interactions that satisfy engagement criteria defined by the pricing structure. The term “engagement” in this context applies only to player interactions that satisfy defined engagement criteria. The total cost to the advertiser for publication of an advertising campaign according to this pricing structure would thus be variable as a function of a total number of player engagements with associated advertising content published on the in-game advertising platform. Note that payment for publication of the advertising content is described variously as the publisher's price or as the advertiser's cost, and that these terms are used interchangeably herein.

The pricing scheme may further define a number of different engagement types, each of which has a separate respective price. Each engagement type may have respective engagement criteria defined by the pricing structure, also referred to as respective engagement goals.

In one example embodiment, the advertising pricing structure defines at least two engagement types, differentiated at least in part by whether or not the relevant player interaction results in completion by the player of a customer transaction with the advertiser. A customer transaction comprises a commercial engagement between the player and the advertiser, with the player being a customer of the advertiser with respect to goods or services associated with the published advising content. This time of engagement goal is often referred to in the art as an acquisition, in that the advertiser acquires the player as a customer because of the relevant interactive advertising material. Note that a customer transaction by a player who is an existing client or registered customer of the relevant advertiser may in some embodiments be deemed to be a customer acquisition consistent with the relevant pricing structure. In other embodiments, the pricing structure may define customer acquisition engagement as being limited to new or first-time customers of the advertiser.

This engagement type is known as, and further referred to herein as a Cost Per Acquisition (CPA) pricing mechanism. Further herein, player interactions that satisfy a CPA engagement goal are referred to as CPA engagements or actions, while content targeted to facilitate a CPA engagement is referred to as CPA content. Likewise, a CPA prompt means content displayed on a user device to prompt a player to CPA engagement, and a CPA incentive means an incentive offered or provided to the player for CPA engagement.

Such an example embodiment may further comprise a second engagement type having engagement goals or criteria that does not require completion of a customer transaction. This engagement type is further referred to as a Cost Per Engagement (CPE) pricing mechanism. CPE goals may define a minimum level of player interaction for an activity to qualify for CPE pricing. The minimum level of player interaction may, for example, include performance of at least one or more specified interactions, for example being satisfied by replay of video content on a user device. Instead, or in addition, the CPE criteria may specify a threshold level for a score or assessment indicating the quality of a player's performance of an associated activity, for example requiring a minimum score in a survey performed by the player on the advertiser platform.

Further herein, player interactions that satisfy a CPE engagement goal are referred to as CPE interactions or engagements, while content targeted to facilitate a CPE interaction is referred to as CPE content. Likewise, a CPE prompt means content displayed on a user device to prompt a CPE interaction, and a CPE incentive means an incentive offered or provided to the player for CPE engagement.

Note that the CPE criteria in this embodiment require player interaction that is more than mere impression or display of the advertising content. For example, display of on an on-screen banner ad together with an option to watch an associated video advertisement may be defined as an insufficient level of interaction for satisfying the CPE criteria, and would incur no costs to the advertiser. CPE interaction in such case may occur if the player, for example, selects to watch the video. Watching the video does not, however, satisfy the CPA criteria.

In this example embodiment, as is generally the case, the pricing structure provides for CPA prices that are higher than CPE prices. The reason for this price differential is, at least, that CPA activities (such as online purchase of a or subscription to a service) is of greater value to the advertiser than CPE activities (such as interactive exposure to product information). It is thus in the interests of both the advertisers and a provider of the publication service to promote or increase CPA interaction frequency and/or volume.

To this end, the example embodiment provides linked publication of CPE content and CPA content. Such linked CPE-CPA presentation may be coordinated to prompt the player to perform a corresponding linked series or sequence of CPA and CPE interactions with respect to the published advertising content. In some embodiments, CPE content or CPE prompts are provided earlier in the sequence. This has the effect of providing engaged exposure to promotional information about the relevant product/service, before being presented with linked CPA prompt. In some cases, presentation of the CPA prompt may be conditional upon performance by the player of an associated CPE interaction. The linked CPE-CPA presentation thus feeds or funnels successful CPE engagements to presentation of CPA opportunities.

The method may further comprise incentivizing player interaction by offering in-game benefits or rewards to the player for interacting with the advertising content. Note that, with respect to CPA engagements, a provider of the game and/or of the ad publication service is a third party to the facilitated transaction between the player and the advertiser, by facilitating and/or incentivizing a customer transaction between a customer (the player) and a supplier (the advertiser). The method may comprise offering and/or providing separate CPA rewards offer and providing separate incentives for CPA and CPE actions respectively. In such case, the CPA incentives may be greater in value that associated CPE incentives in the same linked sequence.

Note that the term “advertiser” is not strictly limited to a business providing a product or service promoted in the interactive advertising content, but can include any associated ad-provider, sponsor, or other intermediary. In some cases, the integrated in-game interface provides a common or global player experience/interaction to users/players of online games for advertising content published on an advertising platform thus provided within the online game.

The systems and methods may present advertisements and other advertising content or promotional material in various formats, such as JPEG, video, HTML5, and so on. For example, different media inputs are converted to a single user interface (UI) to provide a uniform, transparent experience to the player. That is, the entire player experience, from load to completion (and any interaction with the media, such as rewards), may take place within the single UI, among other things.

Publication or presentation of the interactive advertising content may be arranged and coordinated to prompt or facilitate a sequence of linked activities satisfying different respective engagement criteria. Such prompted or facilitated engagement actions (satisfying, for example, the respective applicable CPA or CPE criteria) is also referred to as sponsored activities. Comprise a sequence of sponsored activities for performance by the player, with at least one of the sequence of sponsored activities being a gated activity which is available to the player only if the player has performed a corresponding preceding activity in the sequence.

The sequence of sponsored activities may be presented as a substantially uninterrupted linked series of activities, with the performance of each activity making available a successive activity in the series. Progression along the sequence of sponsored activities may be subject to player input, so that the player has the option of performing all of the sponsored activities in the sequence, or of performing only a subset of the sequence.

The sequence of sponsored activities may be presented to the user in response to occurrence of a trigger event in the computer-implemented game, for example comprising a friction point in a game fiction. In such a case, the method may include presenting to the user a plurality of alternative options for resolving the friction point, with one of the plurality of options being presentation of the sequence of sponsored activities. For example, in certain games, players may run out of energy before a game concludes. Within these games, the systems and methods described herein may present a dialog box to the player that indicates an option to watch an advertisement in order to receive additional energy and continue playing the game. Once the player views the advertisement, the game provides supplemental energy to the player. In other embodiments, a friction point in the game fiction may comprise a challenge to be overcome by a player, e.g., defeating a boss character or the like.

As discussed, the sequence of sponsored activities may comprise a plurality of different types of activities, for example including two or more of an advertisement, video content, a survey related to a brand or product, an interactive mini-game, or the like. In some embodiments, the sequence of sponsored activities include a video activity in which video content related a brand or product is displayed on the user device, and a subsequent interactive survey about the video content.

In some embodiments, the benefit for player interaction with the interactive advertising content comprises a separate reward for each of the sponsored activities in the sequence. In such cases, the rewards may, in general, progressively increase in value with progression along the sequence.

These and other example embodiments are described, by way of example, in further detail below.

### Example Systems

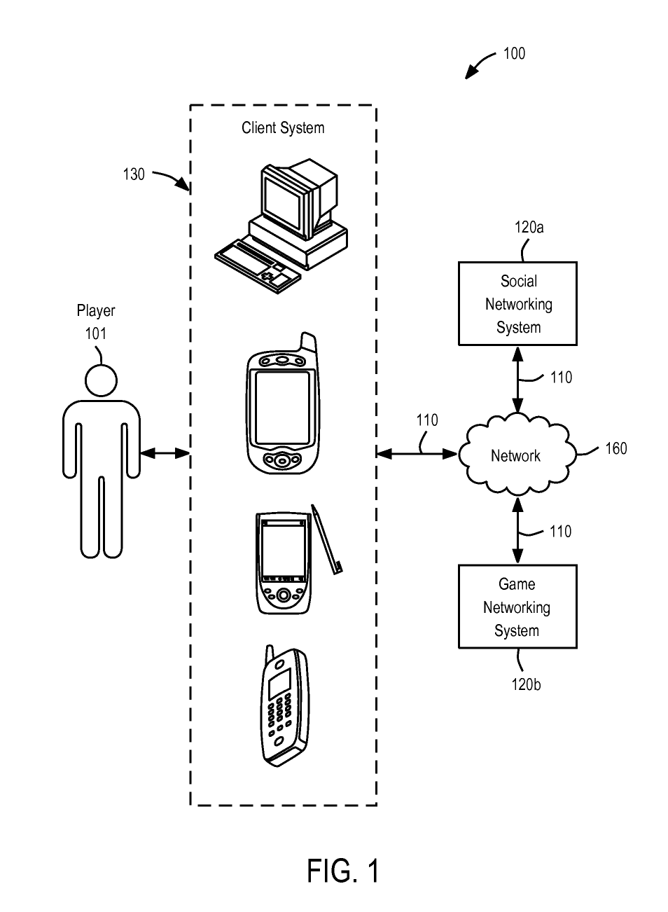

FIG. 1 illustrates an example of a system 100 for implementing various disclosed embodiments. In particular embodiments, the system 100 comprises a player 101, a social networking system 120a, a game networking system 120b, a client system 130, and a network 160. The components of the system 100 may be connected to each other in any suitable configuration, using any suitable type of connection. The components may be connected directly or over a network 160, which may be any suitable network. For example, one or more portions of the network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

The social networking system 120a may be a network-addressable computing system that can host one or more social graphs. The social networking system 120a may generate, store, receive, and transmit social networking data. The social networking system 120a may be accessed by the other components of the system 100 either directly or via the network 160. The game networking system 120b is a network-addressable computing system that may host one or more online games. The game networking system 120b may generate, store, receive, and transmit game-related data, such as, for example, game account data, game input, game state data, and game displays. The game networking system 120b may be accessed by the other components of the system 100 either directly or via network 160. The player 101 may use the client system 130 to access, send data to, and receive data from the social networking system 120a and the game networking system 120b. The client system 130 may access the social networking system 120a or the game networking system 120b directly, via the network 160, or via a third-party system. For example, the client system 130 may access the game networking system 120b via the social networking system 120a. The client system 130 may be any suitable computing device, such as a personal computer, laptop, cellular phone, smart phone, computing tablet, and so on.

The components of the system 100 may be connected to each other using any suitable connections 110. For example, the suitable connections 110 may include wireline (e.g., Digital Subscriber Line (DSL) or Data Over Cable Service Interface Specification (DOCSIS)), wireless (e.g., Wi-Fi or Worldwide Interoperability for Microwave Access (WiMAX)) or optical (e.g., Synchronous Optical Network (SONET) or Synchronous Digital Hierarchy (SDH)) connections. One or more connections 110 may include an ad hoc network, an intranet, an extranet, a VPN, a LAN, a WLAN, a WAN, a WWAN, a MAN, a portion of the Internet, a portion of the PSTN, a cellular telephone network, another type of connection, or a combination of two or more such connections. The connections 110 need not necessarily be the same throughout the system 100. One or more first connections 110 may differ in one or more respects from one or more second connections 110.

In an online computer game, a game engine manages a game state of the game. The game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs), and in-game objects. The game engine also manages game state, including player character state for currently active (online) and inactive (offline) players.

An online game may be hosted by the game networking system 120b, which can be accessed using any suitable connection 110 with a suitable client system 130. A player 101 may have a game account on the game networking system 120b, wherein the game account can contain a variety of information associated with the player 101 (e.g., the player's personal information, financial information, purchase history, player character state, game state). In some example embodiments, the player 101 may play multiple games on the game networking system 120b, which may maintain a single game account for the player 101 with respect to all the games, or multiple individual game accounts for each game with respect to the player 101. In some example embodiments, the game networking system 120b may assign a unique identifier to each player 101 of an online game hosted on the game networking system 120b. The game networking system 120b may determine that a player 101 is accessing the online game by reading the user's cookies, which may be appended to HTTP requests transmitted by the client system 130, and/or by the player 101 logging onto the online game.

In some example embodiments, the player 101 may access an online game and control the game's progress via the client system 130 (e.g., by inputting commands to the game at the client device). The client system 130 may display the game interface, receive inputs from the player 101, transmit user inputs or other events to the game engine, and receive instructions from the game engine. The game engine can be executed on any suitable system (e.g., the client system 130, the social networking system 120a, and/or the game networking system 120b). For example, the client system 130 may download client components of an online game, which are executed locally, while a remote game server, such as the game networking system 120b, provides backend support for the client components and may be responsible for maintaining application data of the game, processing the inputs from the player 101, updating and/or synchronizing the game state based on the game logic and each input from the player 101, and transmitting instructions to the client system 130. As another example, each time the player 101 provides an input to the game through the client system 130 (e.g., by typing on the keyboard or clicking the mouse of client system 130), the client components of the game may transmit the player's input to the game networking system 120b.

In an online multiplayer game, players may control player characters (PCs), a game engine controls non-player characters (NPCs) and game features, and the game engine also manages player character state and game state and tracks the state for currently active (i.e., online) players and currently inactive (i.e., offline) players. A player character can have a set of attributes and a set of friends associated with the player character. As used herein, a term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), and so forth. The game engine may use the player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player 101.

In some example embodiments, the player 101 may access particular game instances of an online game. A game instance is a copy of a specific game play area that is created during runtime. In some example embodiments, a game instance is a discrete game play area where one or more players 101 may interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In some example embodiments, a game instance is populated by one or more player characters controlled by one or more players 101 and one or more in-game objects controlled by the game engine. When accessing an online game, the game engine may allow the player 101 to select a particular game instance to play from a plurality of game instances. Alternatively, the game engine may automatically select the game instance that the player 101 will access. In some example embodiments, an online game comprises only one game instance that all players 101 of the online game can access.

In some example embodiments, a specific game instance may be associated with one or more specific players 101. A game instance is associated with a specific player 101 when one or more game parameters of the game instance are associated with the specific player 101. For example, a game instance associated with a first player 101 may be named “First Player's Play Area.” This game instance may be populated with the first player's PC and one or more in-game objects associated with the first player 101. In some example embodiments, a game instance associated with a specific player 101 may only be accessible by that specific player 101. For example, a first player 101 may access a first game instance when playing an online game, and this first game instance may be inaccessible to all other players 101. In other embodiments, a game instance associated with a specific player 101 may be accessible by one or more other players, either synchronously or asynchronously with the specific player's game play. For example, a first player 101 may be associated with a first game instance, but the first game instance may be accessed by all first-degree friends in the first player's social network. In some example embodiments, the game engine may create a specific game instance for a specific player 101 when that player 101 accesses the game. For example, the game engine may create a first game instance when a first player 101 initially accesses an online game, and that same game instance may be loaded each time the first player 101 accesses the game. For example, the game engine may create a new game instance each time a first player 101 accesses an online game, wherein each game instance may be created randomly or selected from a set of predetermined game instances. In some example embodiments, the set of in-game actions available to a specific player 101 may be different in a game instance that is associated with that player 101 compared to a game instance that is not associated with that player 101. The set of in-game actions available to a specific player in a game instance associated with that player 101 may be a subset, superset, or independent of the set of in-game actions available to that player 101 in a game instance that is not associated with him. For example, a first player 101 may be associated with Blackacre Farm in an online farming game. The first player 101 may be able to plant crops on Blackacre Farm. If the first player 101 accesses a game instance associated with another player 101, such as Whiteacre Farm, the game engine may not allow the first player 101 to plant crops in that game instance. However, other in-game actions may be available to the first player 101, such as watering or fertilizing crops on Whiteacre Farm.

In some example embodiments, a game engine can interface with a social graph. Social graphs are models of connections between entities (e.g., individuals, users, contacts, friends, players, player characters, non-player characters, businesses, groups, associations, concepts, and the like). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some example embodiments, a unique client identifier can be assigned to each user in the social graph. This disclosure assumes that at least one entity of a social graph is a player or player character in an online multiplayer game, though this disclosure includes any suitable social graph users.

The minimum number of edges required to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nₘₐₓ degrees of the player, where Nₘₐₓ is the maximum degree of separation allowed by the system managing the social graph (e.g., the social networking system 120a or the game networking system 120b). In some example embodiments, Nₘₐₓ equals 1, such that the player's social network includes only first-degree friends. In some example embodiments, Nₘₐₓ is unlimited and the player's social network is coextensive with the social graph.

In some example embodiments, the social graph is managed by the game networking system 120b, which is managed by the game operator. In other embodiments, the social graph is part of a social networking system 120a managed by a third-party (e.g., Facebook®, Friendster, Myspace). In other embodiments, the player 101 has a social network on both the game networking system 120b and the social networking system 120a, wherein the player 101 can have a social network on the game networking system 120b that is a subset, superset, or independent of the player's social network on the social networking system 120a. In such combined systems, the game network system 120b may maintain social graph information with edge type attributes that indicate whether a given friend is an “in-game friend,” an “out-of-game friend,” or both. The various embodiments disclosed herein are operable when the social graph is managed by social networking system 120a, game networking system 120b, or both.

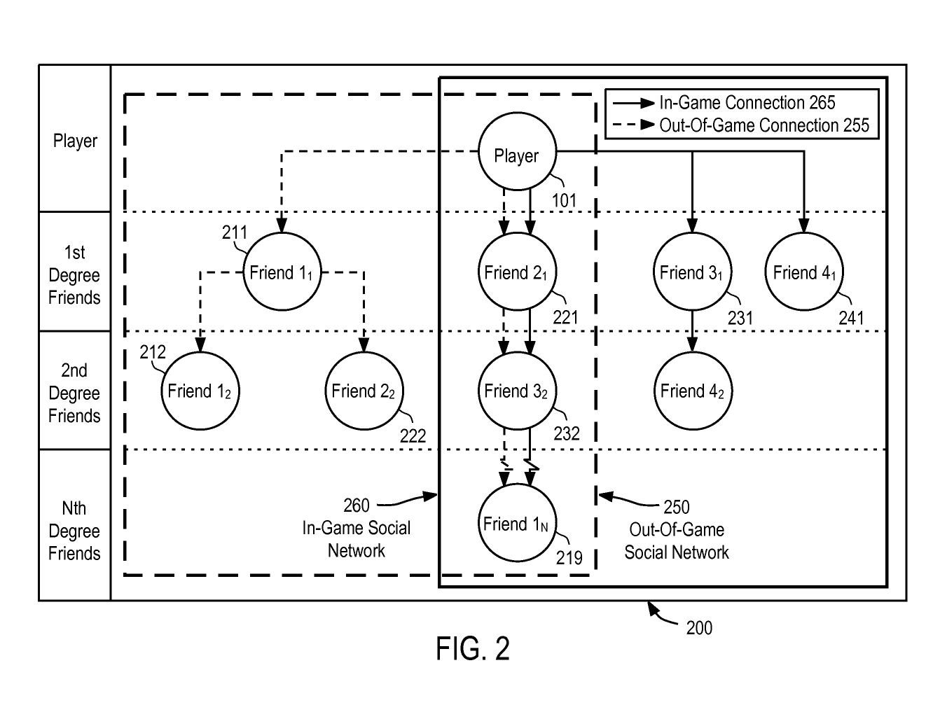

FIG. 2 shows an example of a social network 200 within a social graph. As shown, Player 201 can be associated, connected, or linked to various other users, or “friends,” within the social network 250. These associations, connections or links can track relationships between users within the social network 250 and are commonly referred to as online “friends” or “friendships” between users. Each friend or friendship in a particular user's social network within a social graph is commonly referred to as a “node.” For purposes of illustration and not by way of limitation, the details of the social network 250 will be described in relation to Player 201. As used herein, the terms “player” and “user” can be used interchangeably and can refer to any user or character in an online multiuser game system or social networking system. As used herein, the term “friend” can mean any node within a player's social network.

As shown in FIG. 2, Player 201 has direct connections with several friends. When Player 201 has a direct connection with another individual, the connection is referred to as a first-degree friend. In the social network 250, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211. The limit on the depth of friend connections, or the number of degrees of separation for associations, that Player 201 is allowed is typically dictated by the restrictions and policies implemented by social networking system 120a.

In some example embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may take advantage of and utilize the distinction between the various degrees of friendship relative to Player 201.

In some example embodiments, a player (or player character) may have a social graph within an online multiplayer game that is maintained by the game engine and another social graph maintained by a separate social networking system. FIG. 2 depicts an example of an in-game social network 260 and the out-of-game social network 250. As discussed herein, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. That is, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. For example, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 may have second-degree and higher-degree friends in both his in-game and out of game social networks. In some embodiments, it is possible for Player 201 to have a friend connected to him both in his in-game and out-of-game social networks, wherein the friend is at different degrees of separation in each network. For example, if Friend 2₂ 222 had a direct in-game connection with Player 201, Friend 2₂ 222 would be a second-degree friend in Player 201's out-of-game social network, but a first-degree friend in Player 201's in-game social network. In particular embodiments, a game engine can access the in-game social network 260, the out-of-game social network 250, or both.

In some example embodiments, the connections in a player's in-game social network can be formed both explicitly (e.g., users should “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

In some example embodiments, the systems and methods described herein provide an integrated in-game interface within a computer-implemented game to a number of different advertisers or advertisement providers. In some cases, the integrated in-game interface provides a common or global player experience/interaction to users/players of online games for advertising content published on an advertising platform thus provided within the online game. The systems and methods may present advertisements and other advertising content or promotional material in various formats, such as JPEG, video, HTML5, and so on. For example, different media inputs are converted to a single user interface (UI) to provide a uniform, transparent experience to the player. That is, the entire player experience, from load to completion (and any interaction with the media, such as rewards), may take place within the single UI, among other things.

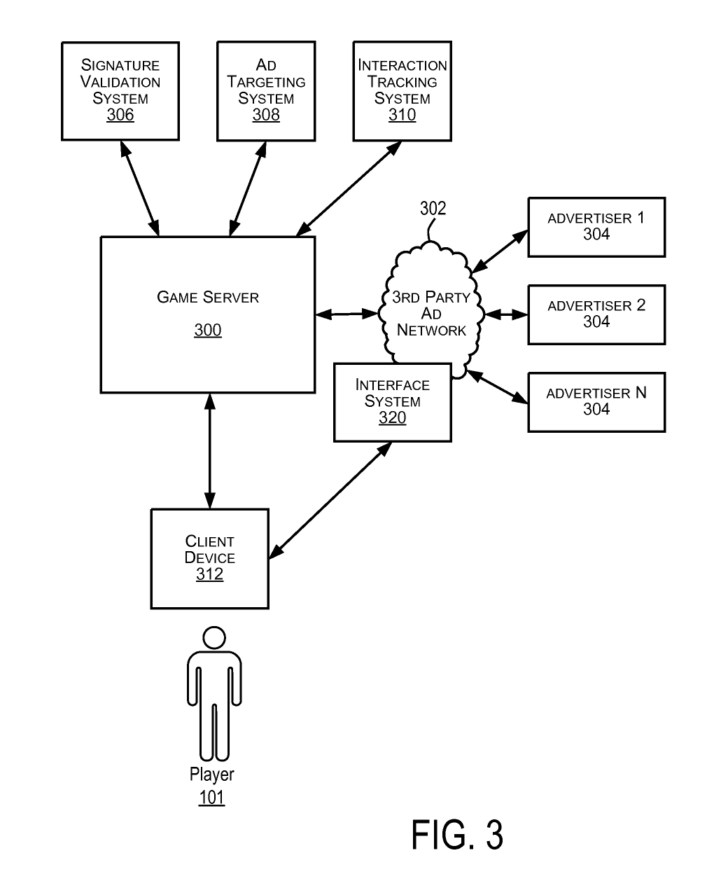

FIG. 3 is a block diagram illustrating an integrated in-game advertising platform, according to an example embodiment. The platform may include a game server 300 that communicates with a third party advertisement network 302 that is configured to provide advertising content from advertisers in the form of various content providers 304 (e.g., advertiser 1, advertiser 2, advertiser N), such as game sponsors and other sponsoring entities. The game server 300 and/or the advertisement network 302 may provide advertisements and other advertising content to the client device 312, such as within or overlaying a game fiction of an online game provided by the game server 300.

The interface system 320 and game server 300 may thus be configured to provide an in-game advertising publication service for publishing interactive advertising content within the game hosted by the game server 300 in accordance with one or more pricing structures that differentiate performance-based advertising costs based on price depreciation for different types of player engagement (e.g., CPA and CPE).

The game server 300 may also communicate with various systems that perform methods associated with presenting advertisements and other advertising content to players via their client devices 312, such as a signature validation system 306 configured to validate devices within the platform, an ad targeting system 308 configured to identify, target, and/or match advertisements to players viewing the advertisement, and/or an interaction tracking system 310 configured to track interactions between players via a client device 312 and interactions with presented advertisements.

The following is an example of different components that may interact between the game server 300 and an interface system 320 associated with the third party advertisement network 302 in order to promote player engagement with interactive advertising content by prompting performance of a linked sequence or series of different types of player engagement with the interactive advertising content, for example by coordinated presentation of linked CPE content and CPA content, as described above. Such interaction of players 101 with advertising content published within the game is also referred to herein as sponsored activities. Prompting interaction with advertising content may in some embodiment include providing an in-game offering interaction with advertising content as an option for resolving friction points within an online game. Features of the interface system 320 may, for example, be integrated in the game server 300. Alternatively, the functions of the various processing components of FIG. 3 may be performed by distributed processing devices.

Once an online game is launched, the game server 300 initializes Flash based on an initUser transaction. The game server 300 fetches targeting information from a targeting service, such as the ad targeting system 308. At the same time or in parallel, the game server 300 initializes the online game code (e.g., game html or JavaScript), by (1) fetching 3PAN playloads from a ZRuntime script, and (2) outputting an appropriate 3PAN payload into a page stream to create a 3PAN JavaScript module which can retrieve interactive content from the third party advertisement network 302. At a friction point, the game server 300, via Flash, identifies available content. If available, the game server 300 presents an option to view the content, and when the player selects the option, the 3PAN payload calls a load function with a pointer to the div/frame that is rendering the retrieved content. Upon completion of a presentation of the content, the 3PAN payload transmits a “completed message” to the game server 300, and closes the content window. The game server 300 then resolves the friction point by granting energy or performing other operations within the online game.

In some example embodiments, displayed advertising content may be in a rich-media format, and include a video piece along with a survey or quiz questions, although in some cases, the advertisements may include arbitrary web content (pure video, display only, rich media, and so on). In some example embodiments, the game server 300 may utilize an IFrame window triggered from a Flash or HTML5 game client as the content placement mechanism.

In some example embodiments, the interface system 320 may provide an SDK that reduces in-game integration costs, among other things. The SDK may also provide uniform tracking and allow the interface system 320 to manage and onboard new advertisement networks and/or content providers without game studio development involvement. The system may also integrate with a targeting engine, such as ad targeting system 308, providing the ability to target the advertising content of respective sponsored activities in a sequence of activities themselves, as well as target in-game placements to different player segments based on their geography, demographics, behavior, and so on.

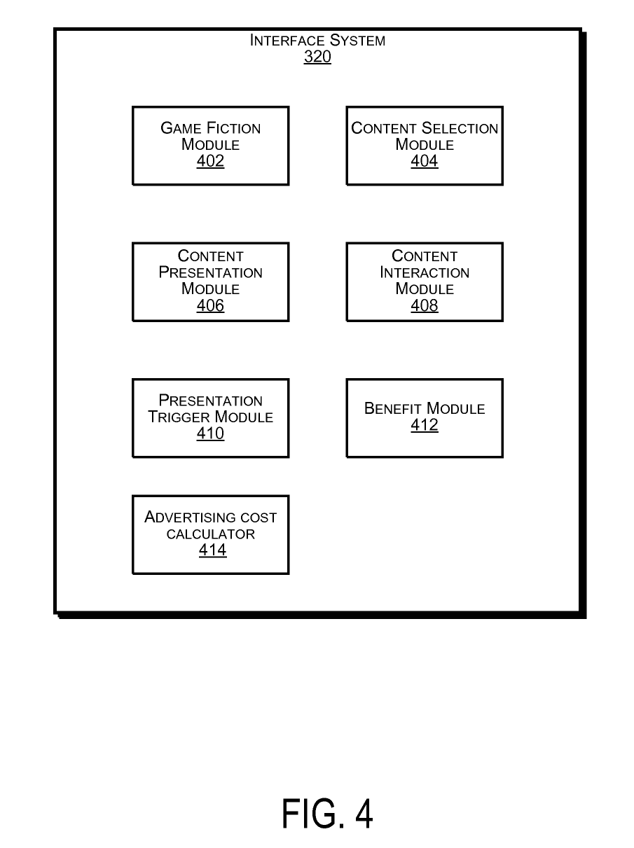

FIG. 4 is a block diagram illustrating the interface system 320, in some example embodiments. The interface system 320 may include various hardware and/or software modules, such as a game fiction module 402, a content selection module 404, a content presentation module 406, a content interaction module 408, a presentation trigger module 410, a benefit module 412, and an advertising cost calculator 414.

In some example embodiments, the game fiction module 402 is configured and/or programmed to receive an indication of an occurrence of a trigger event within a game fiction of an online game. For example, the game fiction module 402 may receive from the game server 300 an indication that a player of an online game has arrived at a friction point or pinch point within a game fiction, such as an occurrence of a player running out of energy, having a low or empty account of virtual currency, failing a task or quest within the online game, and so on. In some embodiments, the trigger event may comprise user selection of an option associated with presentation of interactive advertising content, for example in response to presentation on the client device 312 of a corresponding prompt. In such case, the presentation trigger module 410 may be configured to present a plurality of alternative options to the player in response to, for example, a friction point in the game fiction, one of the alternative options being to interact with advertising content.

In some example embodiments, the game content selection module 404 is configured and/or programmed to select interactive advertising content from a group of content providers, to be presented to the player of the online game. For example, the content selection module 404 may select interactive content (e.g., an interactive advertisement such as a video, quiz, and so on) from the advertisers 304, based on information received from the game server 300, such as information from the ad targeting system 308 that provides information associated with characteristics of a player playing the online game, a state of the online game, and so on. In some example embodiments, the content presentation module 406 is configured and/or programmed to directly (or, indirectly via the game server) present the interactive content to a user device associated with a player of an online game. For example, the content presentation module 406 directly presents the interactive content to the client device 312 by overlaying the content over an online game provided by the game server 300 that is currently running on the client device 312.

In some example embodiments, the content interaction module 408 is configured and/or programmed to determine that the player of the online game has interacted with the presented interactive content. For example, the content interaction module 408 may determine that a video has played, a player has answered one or more questions from a displayed interactive quiz, may receive an indication from the game server 300 that the player has viewed the content, and so on. The content interaction model 408 may also be configured to identify transactions between the player 101 and an advertiser 304 based on or facilitated via presented advertising content. The content interaction module 408 may further be configured to determine an engagement type of the interaction, according to the relevant pricing structure, for example to discriminate between CPA and CPE interactions.

Once it has been determined that the player has interacted with the presented interactive content, the game fiction module 402 may transmit to the game server 300 an indication that the player has interacted with the presented interactive content, and the benefit module 412 may provide a benefit to the player 101 based on player interaction with the presented advertising content. The benefit or reward may vary depending on the determined engagement type. In some embodiments, the benefit may comprise resolution of the friction point in the game fiction.

Incentive rewards or benefits provided to players for CPA and/or CPE interactions may include resulting friction points in a game fiction. Instead, or in addition, other in-game benefits or items of value may be provided, as described elsewhere herein. For example, when a player arrives at a friction point within a game fiction, the systems and methods may present the player with a variety of options that enable the player to resolve the friction point, including an option associated with a tiered or sequenced group of interactions between the player and advertising content. The player may select the option associated with interacting with tiered content, and, depending on the player's level of interaction with presented content, the systems may provide the player with rewards (e.g., energy, virtual currency, and so on), which enable the player to resolve the friction point and continue playing an online game within the current game fiction, among other things.

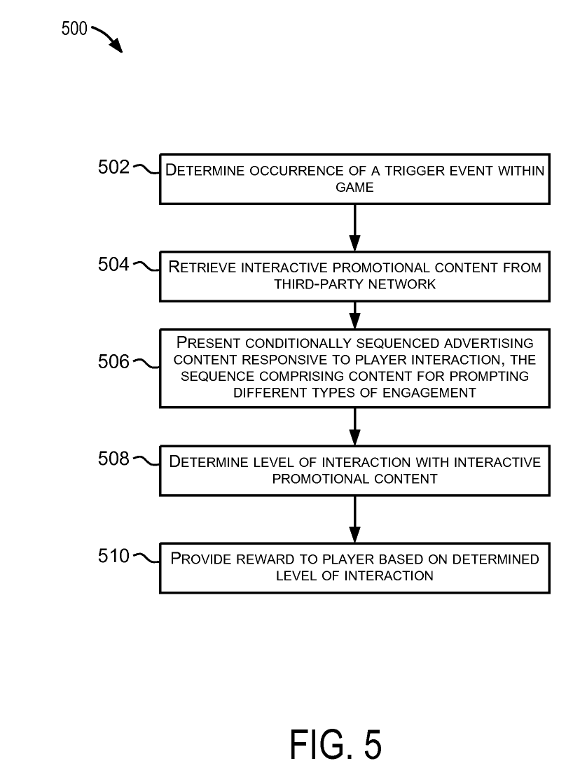

FIG. 5 is a flow diagram illustrating an example embodiment of a method 500 for presenting advertising content to a player of an online game. In operation 502, the interface system 320 determines the occurrence of a trigger event within the game. In this example embodiment, the trigger event is a friction point or pinch point within a game fiction. For example, the game fiction module 402 may receive an indication from the game server 300 that a player has reached a friction point or pinch point within a game fiction.

Example friction points may include running low or out of energy, running low or out of virtual currency, running low or out of time to complete a task or project within the game, failing to complete a task or project within the game, losing a competition within the online game, and so on. In other embodiments, friction points within the game fiction may comprised progression of a player to a particular point within the game fiction, regardless of performance of the player with respect to that point in the game fiction. In some case, for example, a particular in-game challenge or impasse came be overcome only by user interaction with the interactive advertising content, as described below, so that arrival of the player at the predetermined point in the game fiction constitutes a trigger event that causes presentation of interactive advertising content. Trigger events can instead, or in addition, comprise user selection of an option to interact with advertising content for associated benefits.

In operation 504, the interface system 320 retrieves interactive advertising content from a third party network of advertisement providers, the interactive advertising content comprising a sequence of sponsored activities for performance by the player. “Promotional” means content or activities that promote an associated brand, product, or service. “Sponsored” means content or activities provided to players via the game at a cost to an entity (e.g., an advertiser) associated with the promoted brand, product, or service.

For example, the content selection module 404 selects and retrieves interactive advertising content for prompting a plurality of sponsored activities from one of multiple content providers associated with the third party advertisement network 302, the sequence including a plurality of different types of advertising content. In particular, the advertising content selected for presentation to the user in a linked sequence may include both CPE content and CPA content. In this example embodiment, the plurality of sponsored activities retrieved for presentation in a linked sequence are with respect to a common promotional subject matter (e.g., being with respect to a particular product). Thus, for example, the interactive advertising content may comprise a sequence of sponsored activities consisting of a trailer for a movie, a survey or questionnaire about the movie, and an incentivized prompt or link to subscribe to an online provider of streaming video content from which the movies available.

In operation 506, the interface system 320 presents the retrieved interactive content directly to a computing device associated with a player of the online game. For example, the content presentation module 406 overlays a presentation of a retrieved advertisement on top of a currently running game within the client device 312. Presentation of the advertising content, at operation 506, may consist of conditionally sequenced presentation. Thus, the sponsored activities of the sequence may be presented one at time, with presentation of successive activities being conditional upon player performance of a preceding activity.

Considering the above-mentioned example of interactive advertising content for a new movie, the conditionally linked presentation of the sequence of activities may comprise presenting the player with the option of watching the video advertisement consisting of the movie trailer. Upon completion of the movie trailer replay, a message may be displayed informing the player of achieved benefits. For example, the player may be advised that a certain number of in-game power-ups (say, three) have been achieved.

After completion of replay of the movie trailer, the player may be presented with a choice between answering the associated survey, or returning to the game. A benefit associated with answering the survey may be displayed on the client device 312 together with the options. In this example, in-game benefits associated with the respective activities of the promotional sequence progressively increase in value. For example, the player may be informed that completion of the survey would be rewarded by an increased number of power-ups relative to that for watching the movie trailer (say, five). Note that, in this example, the sponsored survey is a gated activity in that it is available to the player only if the player has performed the preceding activity, in this case having watched the trailer. In response to selecting to answer the survey, the survey is presented to the player and the associate benefit accrues to the player.

In this example, both the watching of the video and the completion of the survey are CPE interactions in accordance with the applicable pricing structure. The associated act content is thus referred to as CPE content, with the respective options and associated incentive rewards providing CPE prompts. Likewise, the respective incentive rewards or benefits is understood to be CPE rewards.

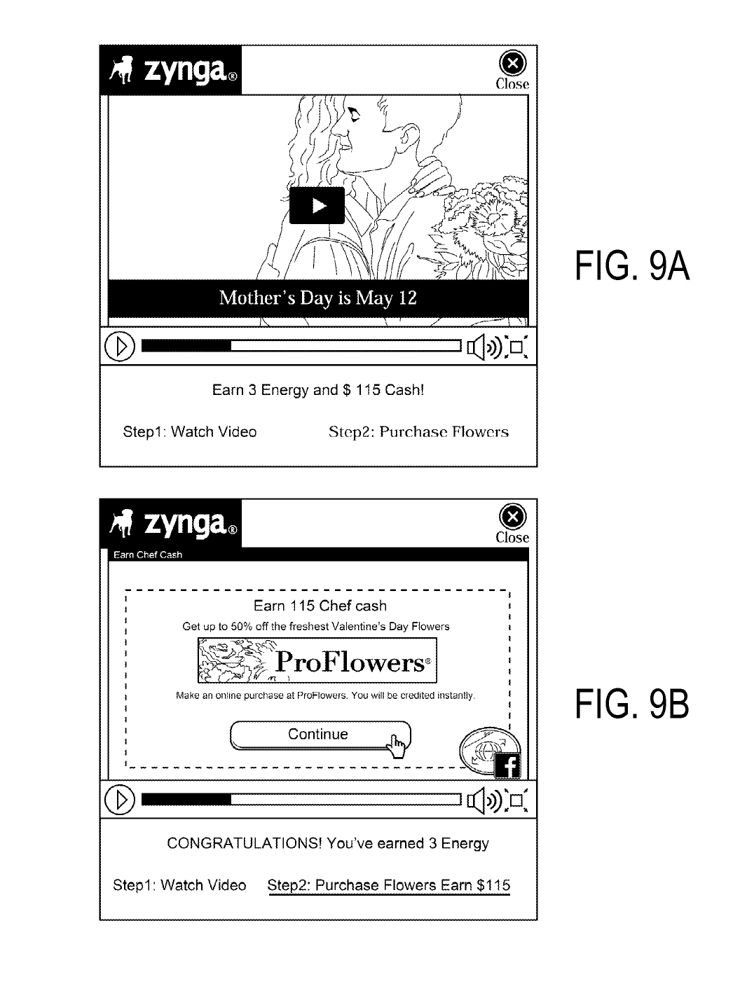

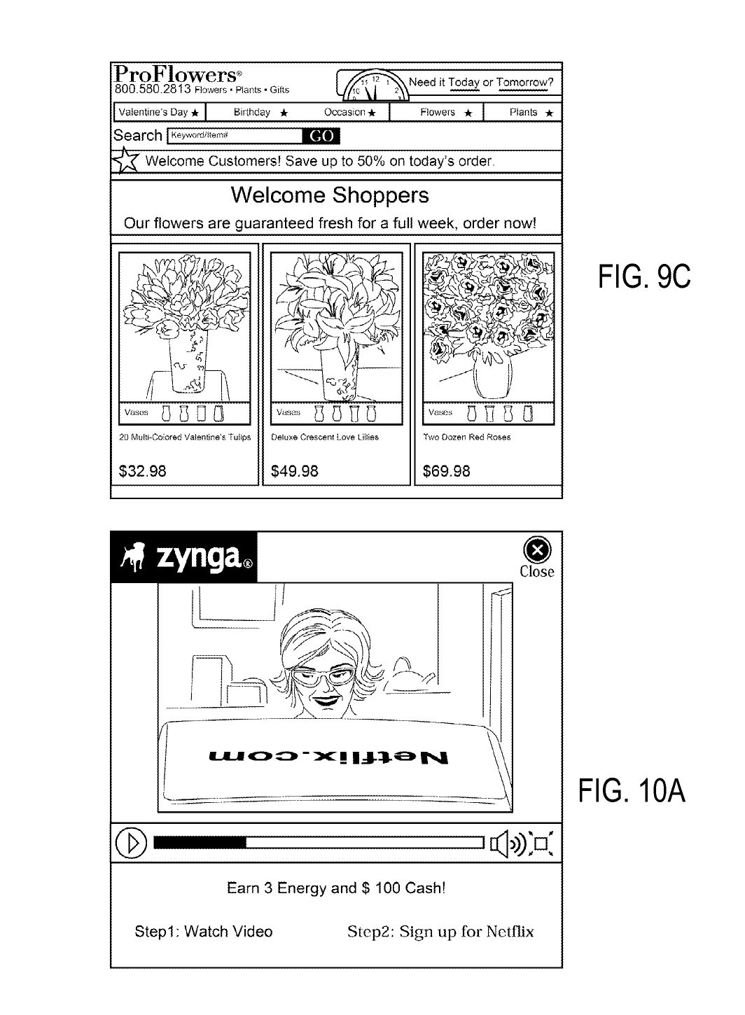

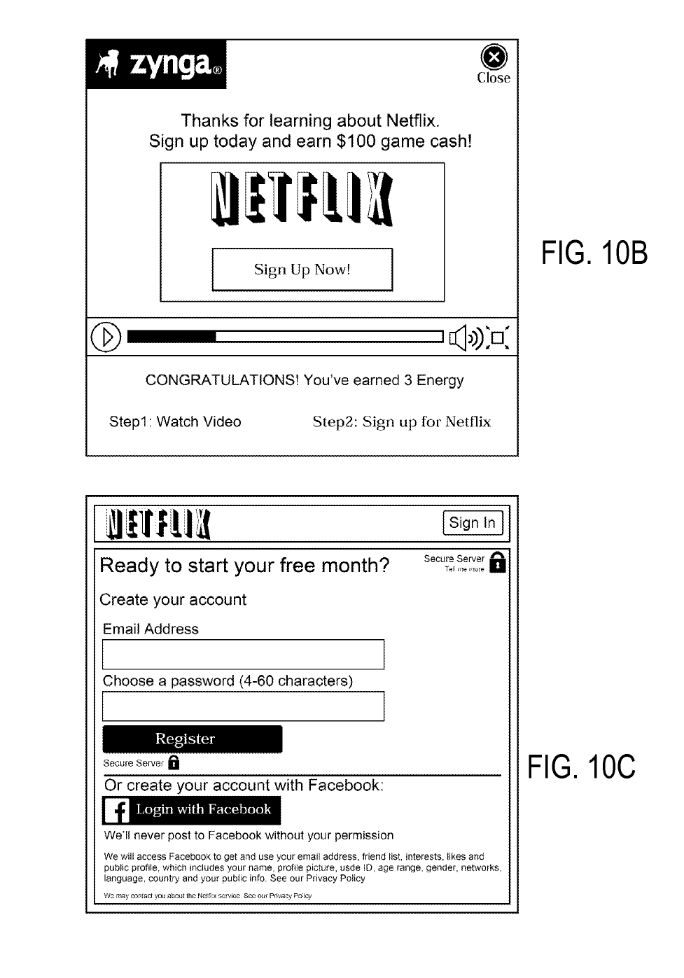

After completion of the survey, the player is in this example embodiment presented with yet another choice. In this example, the player is presented with the option of subscribing to the online streaming service (for example by displaying a user interface such as that shown in FIG. 10B). It will be understood from what has gone before that subscription to the movie service satisfies the engagement criteria for CPA engagement, in that is comprises completion of a customer transaction between the player and the relevant advertiser (see, for example, FIGS. 9 and 10C), with the player being a customer of the advertiser.

Display of the option for subscribing to the service, together with offering an associated incentive is an example of providing a CPA prompt to the player. The subscription engagement is in this example again a gated activity available on the condition that the player has completed the linked survey. The CPA incentive may be greater in value than the that of the CPE rewards in the sequence, in this example being, say, seven power-ups. Note that the sequence of interactions in the above example is presented as a substantially uninterrupted linked series of activities, without any gameplay of the underlying persistent game between neighboring activities.

In operation 508, the interface system 320 determines a level of interaction of the player with the sequentially presented interactive advertising content. Determining the level of interaction may comprise determining the number of activities in the sequence of sponsored activities performed by the user. Note that conditionally sequenced presentation of a plurality of activities, as described above allows the player, at his preference, to perform all of the activities in the sequence or to perform only a subset of the sponsored activities. Determining the level of interaction may in such cases comprise quantifying the performed subset of activities. If, for example, the player performs all three of the above-described activities in the example sequence for promoting a new movie, the subset may be quantified as comprising three activities. If, however, the player opts to return to the game after watching the trailer, the number of performed activities would be determined to be one activity. Should the player opt to exit the linked sequence after answering the survey, the number of activities in the performed subset will be determined as equaling two activities.

In some embodiments, the level of interaction is determined only by the number of activities that the player performs. Instead, or in addition, one or more scores or other performance metrics achieved by the player in at least some of the performed activities may also be taken into account in determining the level of interaction, so that the value of benefits earned by the player is determined, at least in part, by the quality of the player's performance within the sponsored activities. Such performance-based determination of the level of interaction may be applied only to the CPE interactions, with the CPA engagement goals being satisfied by completion of the relevant customer transaction. A score indicative of how many questions in the questionnaire are answered correctly, and/or a score achieved by the player in a CPE minigame may, for example, be factored into determination of the player's level of interaction with the interactive advertising content.

In operation 510, a benefit is provided to the player based on the determined level of interaction with the interactive advertising content. The value of the benefit may be dependent on the determined level of interaction. The value of the achieved benefit may thus be greater for greater levels of interaction. The benefit awarded to the player for interaction with the interactive advertising content may be in-game benefits, for example comprising in-game resources, objects, abilities, currency, or the like. In some examples, the benefit may comprise resolution of an associated friction point in the game fiction. For example, the game server 300 may resolve a friction point by awarding a player energy or virtual currency, by assisting a player with a quest, and so on. In other embodiments, the benefits may include out-of-game benefits, comprising, for example, promotional offers, coupons, discounts, or the like.

Of course, in some example embodiments, the interface system 320 and/or the game server 300 may perform method 600 at various other times within a game fiction, such as other points within a game fiction that may require a player to perform a task or other action with an online game, at times when a player's status or associated metrics indicate a possible need for a reward (e.g., the player is running low on energy), or the like

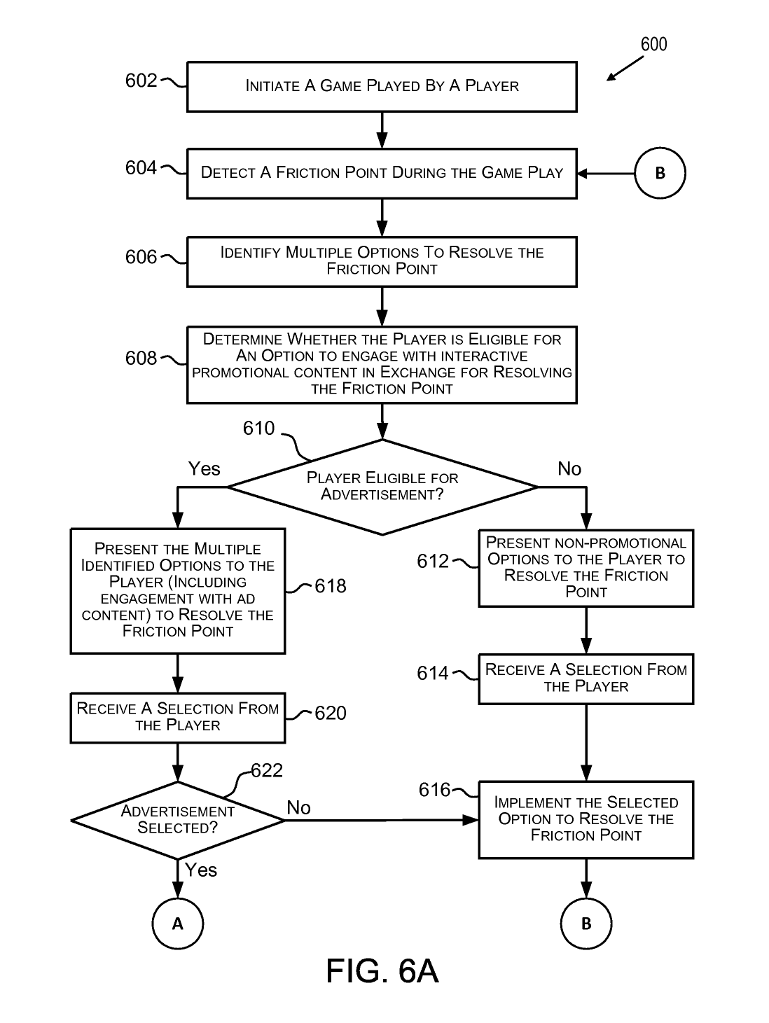

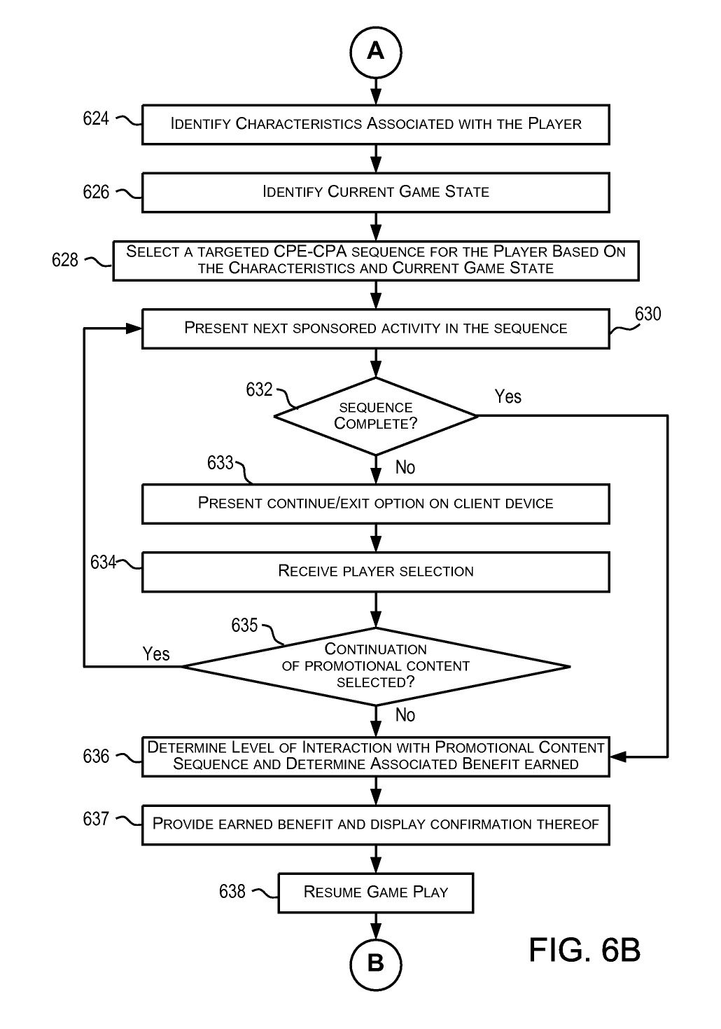

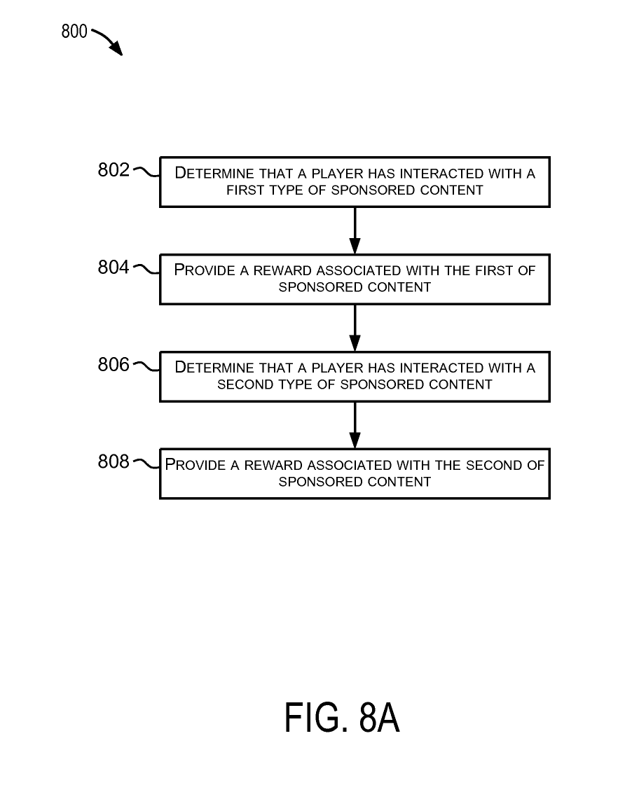

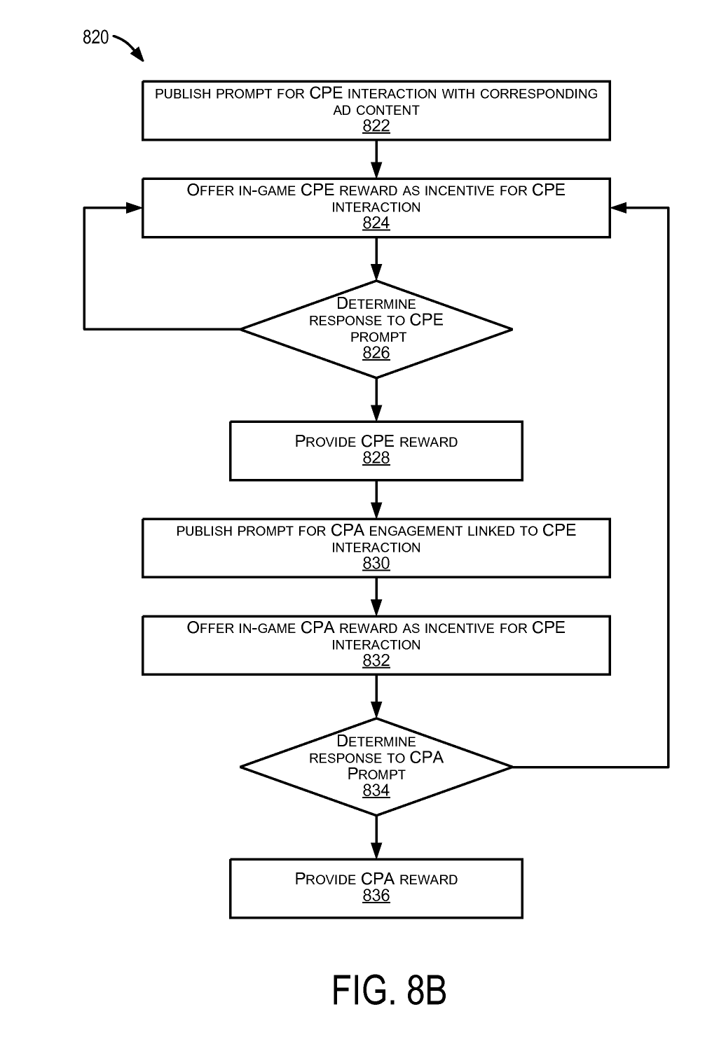

FIGS. 6A-6B are flow diagrams illustrating a more detailed example embodiment of a method performed by the game server 300 and/or the interface system 320, in some example embodiments. In operation 602, the game server 300 initiates a game played by a player. Note that the method described with reference to FIGS. 6A-6B may, with the exception of operation 618 described in more detail below, be performed with respect to linked player engagement sequences that may in some instances present only a single type of player engagement, for example having only CPE engagements. This is to be contrasted with, for example, the methods illustrated by the flow charts of FIGS. 8A and 8B, in which each sequence of linked engagements invariably includes different types of player engagements, and for example having both CPE and CPA interactions.

Returning now to FIG. 6A, In operation 604, the game server 300 detects a friction point during game play. In operation 606, the game server 300 identifies multiple options to resolve the friction point. In operation 608, the game server 300 determines whether the player is eligible for an option to engage with interactive advertising content in exchange for resolving the friction point.

If it is determined, at operation 610, that the player is not eligible for the interactive advertising content, non-promotional options are presented, at operation 612, for resolving the friction point. In operation 614, the game server 300 receives a selection from the player, and, via operation 616, implements the selected non-promotional option to resolve the friction point.

If it is determined, at operation 610, that the player is eligible for being presented with the interactive advertising content, interface system 320, at operation 618, presents the multiple identified options to the player to resolve the friction point, with one of the options being to view/interact with advertising content or advertisement content. In operation 620, a selection is received from the player. In operation 622, when the interactive advertising content is selected, the interface system 320 identifies, via operation 624 of FIG. 6B, characteristics associated with the player. In operation 626, the interface system 320 identifies a current game state. In operation 628, the interface system 320 selects particular targeted interactive advertising content for the player based on the characteristics and on the current game state. In some of the example embodiments described herein, the selection of content at operation 628 may comprise a targeted selection of including both CPE and CPA content.

In operation 630, the selected interactive advertising content is presented to the player. In a first iteration of operation 630, and initial or first sponsored activity in the sequence of sponsored activities of the interactive advertising content is presented to the player (for example comprising the movie trailer in the example embodiment described with reference to FIG. 5). In each successive iteration of operation 630, a successive sponsored activity in the sequence of sponsored activities is presented.

After completion of each of the activities in the sequence, it is determined, at operation 632, whether the sequence is complete, or whether there are remaining sponsored activities in the sequence. If there are further activities in the sequence, options are presented on a game user interface, at operation 633, for the player to continue interaction with the interactive advertising content, or to return to the game. After receiving the relevant user input, at operation 634, the next sponsored activity in the sequence is presented to the player, at operation 630, if it is determined, at operation 635, that the player chose to continue. If not, a level of interaction with the interactive advertising content is determined, at operation 636, as described earlier. The same applies in response to determining, at operation 632, that the sequence is complete.

Thereafter, the particular benefit earned by the determined level of interaction is calculated, at operation 636, and is credited to the player, at operation 637, together with displaying a confirmation thereof on the game user interface. As mentioned, the benefit can comprise resolution of an originally identified friction point, in-game assets, and/or out-of-game benefits. Thereafter, gameplay is resumed, at operation 638.

Thus, in some example embodiments, the game server 300 and various modules of the game server 300 may perform various methods for resolving friction points and other game events via user-selectable advertising options, such as options provided by the various advertisers 304 of the 3rd part advertisement network 302. That is, the game server 300 may include a variety of methods for integrating conditionally sequenced advertising directly into game friction points, pinch points and/or “gates,” such as by determining user eligibility for an advertising offer and displaying the interactive advertising content offer alongside other existing options (e.g., “ask friends”, “buy energy/cash”). When the user selects the advertising option, they are not taken out of the flow of the game and instead the game server 300 may sequentially display a number of different content items and/or activities, responsive to user interaction therewith. Once completed, the game server 300 returns the user to the game with a live update/visual confirmation of the reward item, without requiring a refresh of the game, among other benefits.

As described herein, the game server 300 and/or the 3rd party advertisement server 302 may publish, present, and/or display a variety of different user interfaces to a user via the user client device 312.

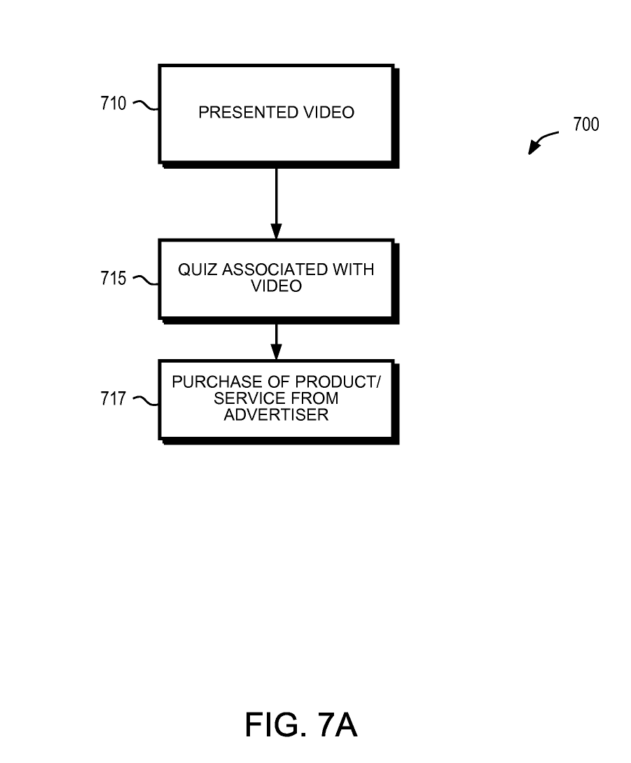

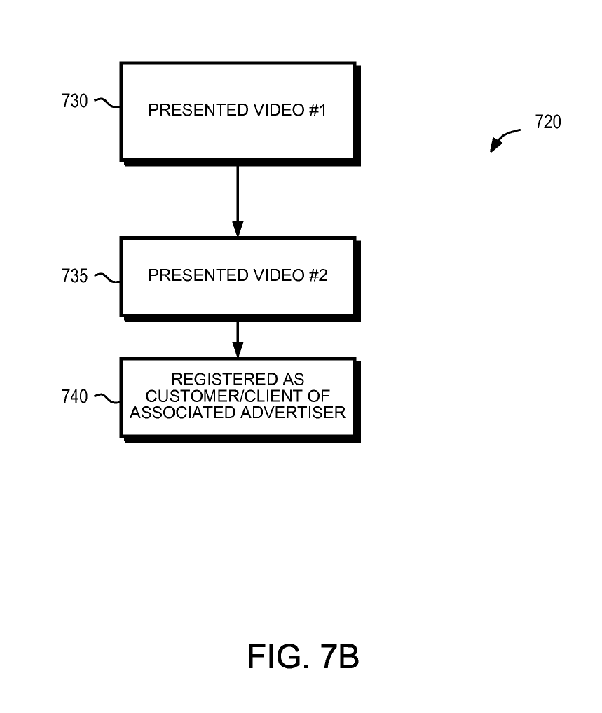

FIGS. 7A-7B are display sequence diagrams illustrating example displays of sequences of sponsored interactive content, in some example embodiments.

FIG. 7A depicts a sequence of advertising content 700, in which user interface 710 presents a video or other visual content to a player, and user interface 715 presents a quiz associated with the video. Upon the player interacting with the sequence of advertising content presented in the UIs, the systems described herein may utilize method 600 and provide the player with rewards as follows:

when the player watches the video 710, the system provides the player with enough currency to resolve a friction point within the game; and

when the player watches the video 710 and takes the quiz 715, the system provides the player with enough currency to resolve a friction point within the online game and an additional amount of bonus currency to be used within the online game,

when the quiz is resolved, the system prompts the player to perform a CPA engagement, at 717, by purchasing a product or service associated with the advertising content from the advertiser. The video 710, quiz 715, and CPA prompt 717 may be presented one after the other in a single user interface (UI), or may be presented in separate parallel UIs.

FIG. 7B depicts a sequence of advertising content 720, in a user interface presents a first video 730 or other visual content to a player, and another interface (or, in some embodiment, the same UI) presents a second video 735 or other visual content to a player. Upon the player interacting with the sequence of advertising content, the systems described herein may utilize method 600 and provide the player with rewards as follows:

when the player watches the first video 730, the system provides a first tier of reward energy to the player; and

when the player watches the first video 730 and the second video 735, the system provides the first tier of reward energy and two additional tiers of reward energy;

when the second video is completed, the system prompts the player to perform a CPA engagement, at 740, by registering as a client of the advertiser.

As described herein, in some example embodiments, the systems and methods may present various types of sponsored content within a sequence of sponsored content that is presented to a player during one sessions, during continuous sessions, or during various different sessions within an online game, among other things. In some example embodiments, the systems and methods may generate and present sponsored content that follows a funnel of content that begins with a first type of content (e.g., CPE type content) and ends with a second type of content (e.g., CPA type content). As is the case in the above-described examples, the system may present a player with a short commercial, survey or mini-game (e.g., CPE content), and then upon completion of that initial activity, present the player with a larger or greater reward for completing a CPA type activity outside of the game, such as signing up for a service provided by a sponsor.

FIG. 8A is a flow diagram illustrating a method for providing rewards to a player of an online game based on interactions with different types of content, in some example embodiments. In operation 802, the interface system 320 determines that a player has interacted with a first type of sponsored content. For example, the interface system 320 determines the player has interacted with a CPE type of content, such as by watching a video, taking a survey, answering a quiz, and so on.

In operation 804, the interface system 320 provides a reward to the player that is associated with the first type of sponsored content. For example, the interface system 320 provides a certain amount of virtual currency or energy for a determined engagement with a CPE type advertisement.

In operation 806, the interface system 320 determines that a player has interacted with a second type of sponsored content. For example, the interface system 320 determines the player has interacted with sponsored content outside of the online game, such as CPA type content at a sponsor hosted website (e.g., signing up for a free trial or service with the sponsor).

In operation 808, the interface system 320 provides a reward to the player that is associated with the second type of sponsored content. For example, the interface system 320 provides a certain amount of virtual currency or energy for a determined engagement with a CPA type advertisement, or other outside game engagement depending on the applicable CPA engagement criteria defined by the relevant pricing structure. In some cases, the reward is much larger and/or greater for such an interaction and/or engagement.

FIG. 8B is a flow diagram illustrating another example embodiment of a method 820 for in-game publication of interactive advertising content. At operation 822, a prompt is published for CPE interaction with corresponding and content. FIG. 9A provides an example embodiment of such a CPE prompt. A user interface is initiated from within the game and is provided within a game display (not shown). The CPE user interface of FIG. 9A provides a prompt to watch a video advertisement relating to online purchase of flowers.

The prompt includes the offering of an incentive immediate association with the on-screen presentation of the video content. The method includes, at operation 824, offering an in-game reward (in this case, three energy for the player's in-game player character) for the CPE interaction of watching the video.

At operation 826, it is determined whether or not the player performs the prompted CPE engagement (in the example embodiment of FIG. 9 by clicking on the video play button to start replay of the video advertisement). If not, further link or unrelated CPE prompt are presented to the player at a later time.

If, however, the player has performed the prompted CPE engagement, the associated incentive reward is provided, at operation 828, accruing to the player's in-game assets. At operation 830, a prompt is then presented for a linked CPA engagement. Such an example CPA prompt is shown in FIG. 9B.

The CPA prompt comprises display of another, separate user interface presenting an option to participate in a CPA engagement. In the example embodiment of FIG. 9, the CPA engagement comprises the purchase of flowers from the associated advertiser. Performance of the CPA engagement is facilitated or enabled by provision of a user-selectable user interface element, such as the “Continue” soft button of FIG. 9B.

The CPA prompt includes providing, at operation 832, an incentive reward for the associated CPA engagement. As can be seen in FIG. 9B, the incentive reward is again in-game benefits available to the player. Note, however, that the CPA reward is greater in value and the CPE reward, in this example being $115 of in-game currency.

At operation 832, it is determined whether or not the player has performed the prompted CPA engagement. In the sample embodiment of FIG. 9, the CPA engagement criteria are satisfied only if the player completes a purchase from the advertiser, e.g., by direct online engagement with the advertiser by through a separate user interface (an example of which is shown in FIG. 9C) which is launched responsive to player selection of the “Continue” button of FIG. 9C.

At operation 834, it is determined that the CPA engagement has been performed, responsive to which the CPA reward is paid, at operation 836.

FIG. 10A-C show a corresponding sequence of prompts for another series of linked player engagements, but being associated with a different advertiser, which provides online streaming services. Note that the CPA engagement need not comprise purchase of a product or service, but can instead comprise other customer-provider engagements. In the example of FIG. 10, the CPA engagement comprises an initially free subscription to the advertiser's services.

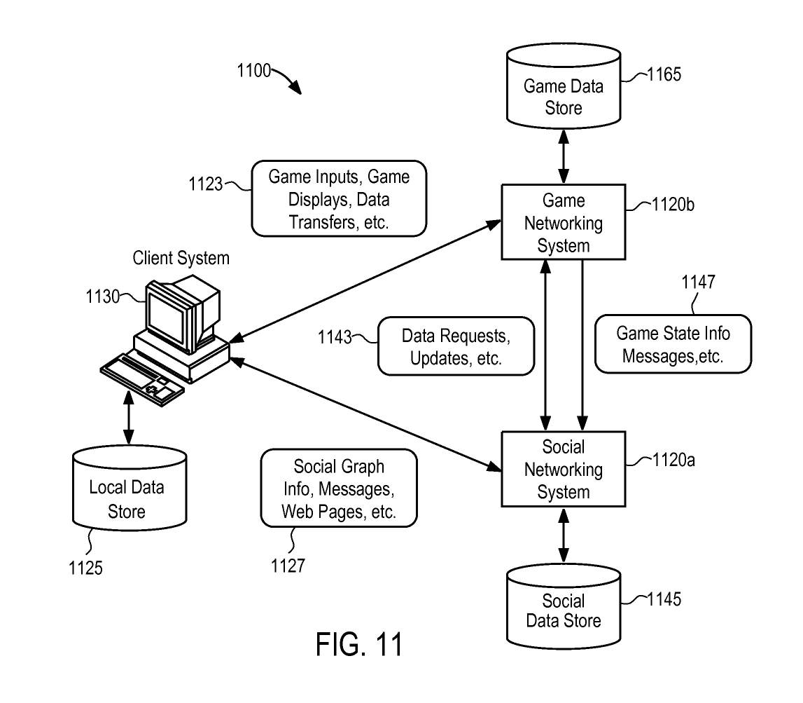

FIG. 11 illustrates an example data flow between the components of system 1100. In particular embodiments, system 1100 can include client system 1130, social networking system 1120a, and game networking system 1120b. The components of system 1100 can be connected to each other in any suitable configuration, using any suitable type of connection. The components may be connected directly or over any suitable network. Client system 1130, social networking system 1120a, and game networking system 1120b can each have one or more corresponding data stores such as local data store 1125, social data store 1145, and game data store 1165, respectively. Social networking system 1120a and game networking system 1120b can also have one or more servers that can communicate with client system 1130 over an appropriate network. Social networking system 1120a and game networking system 1120b can have, for example, one or more internet servers for communicating with client system 1130 via the Internet. Similarly, social networking system 1120a and game networking system 1120b can have one or more mobile servers for communicating with client system 1130 via a mobile network (e.g., GSM, PCS, Wi-Fi, WPAN, and the like). In some embodiments, one server may be able to communicate with client system 1130 over both the Internet and a mobile network. In other embodiments, separate servers can be used.

Client system 1130 can receive and transmit data 1123 to and from game networking system 1120b. This data can include, for example, webpages, messages, game inputs, game displays, HTTP packets, data requests, transaction information, updates, and other suitable data. At some other time, or at the same time, game networking system 1120b can communicate data 1143, 1147 (e.g., game state information, game system account information, page info, messages, data requests, updates, and so forth) with other networking systems, such as social networking system 1120a (e.g., Facebook®, Myspace, and the like). Client system 1130 can also receive and transmit data 1127 to and from social networking system 1120a. This data can include, for example, webpages, messages, social graph information, social network displays, HTTP packets, data requests, transaction information, updates, and other suitable data.

Communication between client system 1130, social networking system 1120a, and game networking system 1120b can occur over any appropriate electronic communication medium or network using any suitable communications protocols. For example, client system 1130, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as HTTP and other communications protocols, such as HTTP-S, FTP, SNMP, TELNET, and a number of other protocols. In addition, a server in one interaction context may be a client in another interaction context. In particular embodiments, the information transmitted between hosts may be formatted as HTML documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 1120b, the BLOB containing the game state for the instance corresponding to the player can be transmitted to client system 1130 for use by a client-side executed object to process. In particular embodiments, the client-side executable may be a FLASH-based game, which can de-serialize the game state data in the BLOB. As a player plays the game, the game logic implemented at client system 1130 maintains and modifies the various game state parameters locally. The client-side game logic may also batch game events, such as mouse clicks, and transmit these events to game networking system 1120b. Game networking system 1120b may itself operate by retrieving a copy of the BLOB from a database or an intermediate memory cache (memcache) layer. Game networking system 1120b can also de-serialize the BLOB to resolve the game state parameters and execute its own game logic based on the events in the batch file of events transmitted by the client to synchronize the game state on the server side. Game networking system 1120b may then re-serialize the game state, now modified, into a BLOB and pass this to a memory cache layer for lazy updates to a persistent database.

With a client-server environment in which the online games may run, one server system, such as game networking system 1120b, may support multiple client systems 1130. At any given time, there may be multiple players at multiple client systems 1130, all playing the same online game. In practice, the number of players playing the same game at the same time may be very large. As the game progresses with each player, multiple players may provide different inputs to the online game at their respective client systems 1130, and multiple client systems 1130 may transmit multiple player inputs and/or game events to game networking system 1120b for further processing. In addition, multiple client systems 1130 may transmit other types of application data to game networking system 1120b.

In particular embodiments, a computer-implemented game may be a text-based or turn-based game implemented as a series of web pages that are generated after a player selects one or more actions to perform. The web pages may be displayed in a browser client executed on client system 1130. As an example and not by way of limitation, a client application downloaded to client system 1130 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF (Small Web Format) object that is embedded in a web page and executable by a Flash media player plug-in. In particular embodiments, one or more described webpages may be associated with or accessed by social networking system 1120a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 1130, either caused by an action of a game player or by the game logic itself, client system 1130 may need to inform game networking system 1120b of the update. For example, if the game is a farming game with a harvest mechanic (such as Zynga® FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 1100 is discussed in reference to updating a multi-player online game hosted on a network-addressable system (such as, for example, social networking system 1120a or game networking system 1120b), where an instance of the online game is executed remotely on a client system 1130, which then transmits application event data to the hosting system such that the remote game server synchronizes game state associated with the instance executed by the client system 1130.

In particular embodiments, one or more objects of a game may be represented as an Adobe® Flash (or other authoring environment, such as HTML5) object. Flash may manipulate vector and raster graphics, and supports bidirectional streaming of audio and video. “Flash” may mean the authoring environment, the player, or the application files. In particular embodiments, client system 630 may include a Flash client. The Flash client may be configured to receive and run Flash application or game object code from any suitable networking system (such as, for example, social networking system 1120a or game networking system 1120b). In particular embodiments, the Flash client may be run in a browser client executed on client system 1130. A player can interact with Flash objects using client system 1130 and the Flash client. The Flash objects can represent a variety of in-game objects. Thus, the player may perform various in-game actions on various in-game objects by making various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 1130, the Flash client may send the events that caused the game state changes to the in-game object to game networking system 1120b. However, to expedite the processing and hence the speed of the overall gaming experience, the Flash client may collect a batch of some number of events or updates into a batch file. The number of events or updates may be determined by the Flash client dynamically or determined by game networking system 1120b based on server loads or other factors. For example, client system 1130 may send a batch file to game networking system 1120b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 1130. In particular embodiments, the batch file may be a text file and the name-value pairs may be in string format.

In particular embodiments, when a player plays an online game on client system 1130, game networking system 1120b may serialize all the game-related data, including, for example and without limitation, game states, game events, and user inputs, for this particular user and this particular game into a BLOB and store the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 1120b may retrieve the corresponding BLOB from the database to determine the most-recent values of the game-related data. In particular embodiments, while a player is playing the online game, game networking system 1120b may also load the corresponding BLOB into a memory cache so that the game system may have faster access to the BLOB and the game-related data contained therein.

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

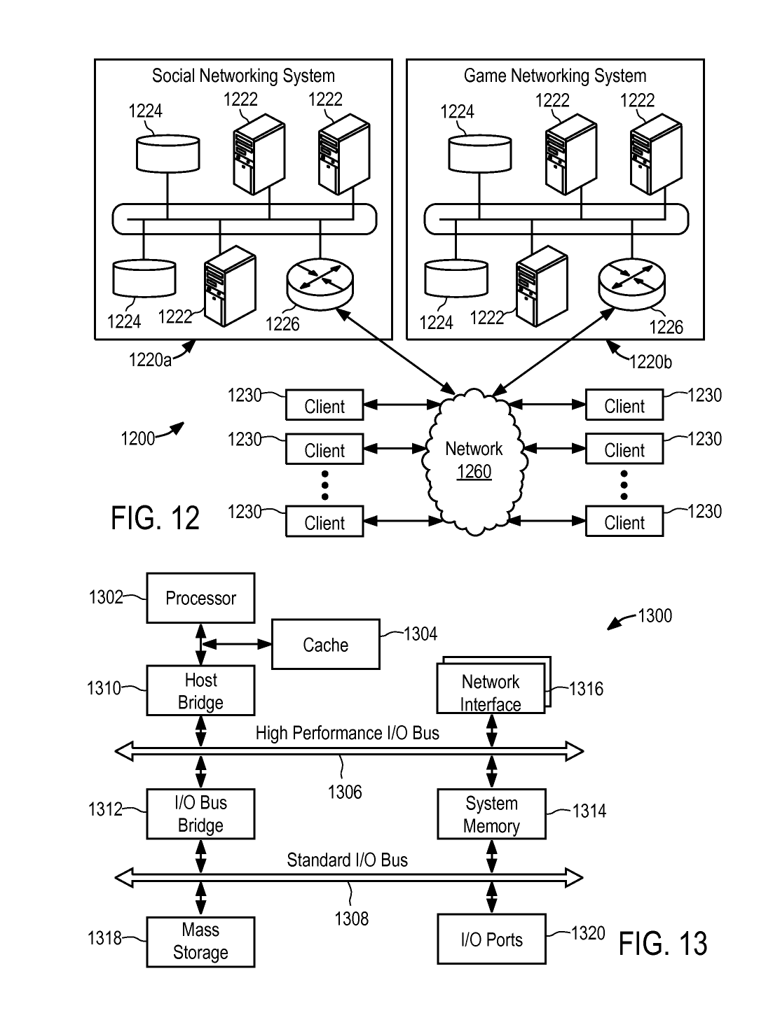

Particular embodiments may operate in a WAN environment, such as the Internet, including multiple network addressable systems. FIG. 12 illustrates an example network environment 1200, in which various example embodiments may operate. Network cloud 1260 generally represents one or more interconnected networks, over which the systems and hosts described herein can communicate. Network cloud 1260 may include packet-based WANs (such as the Internet), private networks, wireless networks, satellite networks, cellular networks, paging networks, and the like. As FIG. 12 illustrates, particular embodiments may operate in a network environment comprising one or more networking systems, such as social networking system 1220a, game networking system 1220b, and one or more client systems 1230. The components of social networking system 1220a and game networking system 1220b operate analogously; as such, hereinafter they may be referred to simply at networking system 1220. Client systems 1230 are operably connected to the network environment via a network service provider, a wireless carrier, or any other suitable means.

Networking system 1220 is a network addressable system that, in various example embodiments, comprises one or more physical servers 1222 and data stores 1224. The one or more physical servers 1222 are operably connected to network cloud 1260 via, by way of example, a set of routers and/or networking switches 1226. In an example embodiment, the functionality hosted by the one or more physical servers 1222 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML, Extensible Markup Language (XML), Java, JavaScript, Asynchronous JavaScript and XML (AJAX), Flash, ActionScript, and the like.

Physical servers 1222 may host functionality directed to the operations of networking system 1220. Hereinafter servers 1222 may be referred to as server 1222, although server 1222 may include numerous servers hosting, for example, networking system 1220, as well as other content distribution servers, data stores, and databases. Data store 1224 may store content and data relating to, and enabling, operation of networking system 1220 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like. Logically, data store 1224 corresponds to one or more of a variety of separate and integrated databases, such as relational databases and object-oriented databases, that maintain information as an integrated collection of logically related records or files stored on one or more physical systems. Structurally, data store 1224 may generally include one or more of a large class of data storage and management systems. In particular embodiments, data store 1224 may be implemented by any suitable physical system(s) including components, such as one or more database servers, mass storage media, media library systems, storage area networks, data storage clouds, and the like. In one example embodiment, data store 1224 includes one or more servers, databases (e.g., MySQL), and/or data warehouses. Data store 1224 may include data associated with different networking system 1220 users and/or client systems 1230.

Client system 1230 is generally a computer or computing device including functionality for communicating (e.g., remotely) over a computer network. Client system 1230 may be a desktop computer, laptop computer, personal digital assistant (PDA), in- or out-of-car navigation system, smart phone or other cellular or mobile phone, or mobile gaming device, among other suitable computing devices. Client system 1230 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 1230 to enter addresses of specific network resources to be retrieved, such as resources hosted by networking system 1220. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is HTML. Other common web browser-supported languages and technologies include XML, the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 1230 desires to view a particular webpage (hereinafter also referred to as a target structured document) hosted by networking system 1220, the user's web browser, or other document rendering engine or suitable client application, formulates and transmits a request to networking system 1220. The request generally includes a URL or other document identifier as well as metadata or other information. By way of example, the request may include information identifying the user, such as a user ID, as well as information identifying or characterizing the web browser or operating system running on the user's client computing device 1230. The request may also include location information identifying a geographic location of the user's client system or a logical network location of the user's client system. The request may also include a timestamp identifying when the request was transmitted.

Although the example network environment described above and illustrated in FIG. 12 is described with respect to social networking system 1220a and game networking system 1220b, this disclosure encompasses any suitable network environment using any suitable systems. As an example and not by way of limitation, the network environment may include online media systems, online reviewing systems, online search engines, online advertising systems, or any combination of two or more such systems.

FIG. 13 illustrates an example computing system architecture, which may be used to implement a server 1222 or a client system 1230. In one embodiment, a hardware system 1300 comprises a processor 1302, a cache memory 1304, and one or more executable modules and drivers, stored on a tangible computer readable medium, directed to the functions described herein. Additionally, hardware system 1300 may include a high performance input/output (I/O) bus 1306 and a standard I/O bus 1308. A host bridge 1313 may couple processor 1302 to high performance I/O bus 1306, whereas I/O bus bridge 1312 couples the two buses 1306 and 1308 to each other. A system memory 1314 and one or more network/communication interfaces 1316 may couple to bus 1306. Hardware system 1300 may further include video memory (not shown) and a display device coupled to the video memory. Mass storage 1318 and I/O ports 1320 may couple to bus 1308. Hardware system 1300 may optionally include a keyboard, a pointing device, and a display device (not shown) coupled to bus 1308. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1300 are described in greater detail below. In particular, network interface 1316 provides communication between hardware system 1300 and any of a wide range of networks, such as an Ethernet (e.g., IEEE 802.3) network, a backplane, and so forth. Mass storage 1318 provides permanent storage for the data and programming instructions to perform the above-described functions implemented in servers 1222, whereas system memory 1314 (e.g., DRAM) provides temporary storage for the data and programming instructions when executed by processor 1302. I/O ports 1320 are one or more serial and/or parallel communication ports that provide communication between additional peripheral devices, which may be coupled to hardware system 1300.

Hardware system 1300 may include a variety of system architectures, and various components of hardware system 1300 may be rearranged. For example, cache memory 1304 may be on-chip with processor 1302. Alternatively, cache memory 1304 and processor 1302 may be packed together as a “processor module,” with processor 1302 being referred to as the “processor core.” Furthermore, certain embodiments of the present disclosure may not require nor include all of the above components. For example, the peripheral devices shown coupled to standard I/O bus 1308 may couple to high performance I/O bus 1306. In addition, in some embodiments, only a single bus may exist, with the components of hardware system 1300 being coupled to the single bus. Furthermore, hardware system 1300 may include additional components, such as additional processors, storage devices, or memories.

An operating system manages and controls the operation of hardware system 1300, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a,” “an,” or “the” is intended to mean “one or more” unless specifically indicated to the contrary. In addition, it is to be understood that functional operations, such as “awarding,” “locating,” “permitting,” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features, and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, and the like), that makes API calls directly to a server. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A method comprising
accessing interactive advertising content to be published for an associated advertiser in accordance with a pricing structure that defines different prices for different types of player engagement with the interactive advertising content; and
publishing the interactive advertising content on a user device associated with a player by causing coordinated presentation on the user device of a linked sequence of prompts for performance of respective player engagements, the linked sequence of prompts including at least two different types of player engagement consistent with the pricing structure.

2. The method of claim 1, wherein the presentation of each prompt may include offering an associated in-game incentive reward for the respective player engagement, with the incentive reforms for different types of player engagement having different corresponding in-game values.

3. The method of claim 2, wherein the coordinated presentation of each prompt comprises display on the user device of a user interface element that is selectable by the player to indicate player-selection of a presented option to perform the corresponding player engagement.

4. The method of claim 2, further comprising associating incentive rewards of greater in-game value for types of player engagement that are higher priced according to the pricing structure.

5. The method of claim 1, wherein the crossing structure defines a first type of advertising content and a second type of advertising content, the second type of advertising content having a higher price per engagement publishing of the interactive advertising content comprises, and wherein the publishing of the interactive advertising content comprises:
identifying that the player has performed a player interaction that is an instance of the first type of player engagement; and
in response to the identified player interaction, presenting advertising content that prompts performance of a further player interaction, the further player interaction being of the second type of player interaction.

6. The method of claim 5, further comprising
providing a first reward to the player for performance of first type of player interaction;
providing a second reward to the player for the performance of the second type, the second reward being of greater value.

7. The method of claim 1, wherein the different types of player engagement comprises
Cost Per Acquisition (CPA) engagements, each of which comprises a customer transaction in which the player is a customer of the advertiser; and
cost per engagement (CPE) interactions which comprises at least a threshold level of non-CPA player interaction with the advertising content.

8. A system comprising:
a content selection module configured for accessing interactive advertising content to be published for an associated advertiser in accordance with a pricing structure that defines different prices for different types of player engagement with the interactive advertising content; and
a content presentation module configured for publishing the interactive advertising content on a user device associated with a player by causing coordinated presentation on the user device of a linked sequence of prompts for performance of respective player engagements, the linked sequence of prompts including at least two different types of player engagement consistent with the pricing structure.

9. A computer readable storage medium storing machine-readable instructions to cause the machine to form operations comprising:
accessing interactive advertising content to be published for an associated advertiser in accordance with a pricing structure that defines different prices for different types of player engagement with the interactive advertising content; and
publishing the interactive advertising content on a user device associated with a player by causing coordinated presentation on the user device of a linked sequence of prompts for performance of respective player engagements, the linked sequence of prompts including at least two different types of player engagement consistent with the pricing structure.
